(19) United States
(12) Patent Application Publication
(10) Pub. No.: US 2006/0272206 A1
(43) Pub. Date: Dec. 7, 2006

(54) Method for attracting game animals using genetically engineered plants

(76) Inventor: Noal Lawhon, McCrory, AR (US)

Correspondence Address: JONDLE & ASSOCIATES P.C., 858 HAPPY CANYON ROAD SUITE 230, CASTLE ROCK, CO, 80108, US

(21) Appl. No.: 11/498,585

(22) Filed: Aug. 3, 2006

Related U.S. Application Data
(63) Continuation-in-part of application No. 10/801,397, filed on Mar. 16, 2004.

(51) Int. Cl. A01M 99/00

(52) U.S. Cl. 47/58.1 R

(57) ABSTRACT

The present invention provides a method of attracting game animals using genetically altered plants. The method involves packaging seeds for plants such as soybeans, corn, canola and other plants species, which have been genetically engineered to make them resistant to the use of broad spectrum herbicides. The purchaser then plants the seed in a food plot adjacent to the area where he desires to attract game animals. Once the seeds have germinated, the food plot is sprayed with a broad spectrum herbicide in order to kill the weeds and improve the yield of the desired plants.

This application is a continuation-in-part of U.S. application Ser. No. 10/801,397, filed Mar. 16, 2004. All publications cited in this application are herein incorporated by reference.

### BACKGROUND OF THE INVENTION

This invention relates to the use and marketing of genetically engineered seeds. More particularly, this invention is directed toward a method for luring game animals using food plots planted with a variety of genetically engineered plants. Yet more particularly, the present invention also includes a method for packaging and marketing a variety of genetically engineered seeds for the purpose of creating a food plot to lure game animals.

Hunters as well as individuals who enjoy watching wildlife often plant food plots in order to enhance the wildlife habitat and attract additional wildlife. This is typically done by selecting an area of land with sufficient sunlight which is also adjacent to cover such as trees or brush. The individual plants seeds of plants selected to attract the desired wildlife. Planting may be accomplished following tillage of the selected site, or it may be accomplished without any tillage. Table 1 below is a partial list of the types of plants and the wildlife they typically attract.

TABLE 1

| PLANT | WILDLIFE ATTRACTED |
|---|---|
| Alfalfa | Deer, turkey, rabbit |
| Austrian Winter Peas | Deer, quail |
| Bahia | Turkey |
| Barley | Deer, dove |
| Birdsfoot Trefoil | Deer, turkey |
| Brome | Deer |
| Buckwheat | Quail, pheasant, dove, duck, deer |
| Canola | Deer, turkey, waterfowl |
| Chicory | Deer |
| Chufas | Deer, turkey, hog |
| Clover | Deer, turkey, rabbit |
| Corn | Deer, turkey, quail |
| Cowpeas | Deer, birds |
| Deer Food | Deer |
| Japanese Millet | Quail, dove, duck |
| Jointvetch | Deer |
| Lablab | Deer |
| Lespedeza | Quail, other game birds, deer |
| Milo | Quail |
| Oats | Deer, dove |
| Rape | Hogs, |
| Rye (cereal) | Deer, dove, turkey |
| Ryegrass | Deer |
| Sorghum Sudangrass | Quail, pheasant, turkey, dove |
| Soybeans | Wildlife, deer |
| Sunflower | Dove, quail, turkey |
| Switchgrass | Quail, turkey, deer |
| Wheat | Deer, quail, turkey |

The plants for the food plots have traditionally used non-genetically engineered seed. Because of this, once the plants germinate and begin growing, it becomes burdensome and costly to remove unwanted weeds from the food plot. These weeds may choke and compete with the desired plants, thus killing the plants or stunting their growth and in turn reducing the yield of food for the wildlife.

The methods currently available for removing the unwanted weeds include physically removing them from the food plot. This involves a great amount of manual labor. Another alternative is to use selective herbicides that control the weeds without killing the desired food plants. Use of multiple herbicides can be somewhat cumbersome in that the type of weeds to be removed must be identified and then the proper herbicide selected, if available. Further, there may be a variety of types of unwanted weeds. Therefore, one herbicide may not kill all of the unwanted weeds. This requires more than one type of herbicide be used. This adds to the cost of killing the weeds. Also, for mixed-seed food plots, an herbicide that is selective to one of the desired crop plants may be toxic to another.

Over the years, broad spectrum herbicides such as glyphosate, glufosinate ammonium, the sulfonylurea class of herbicide chemistries, the imidazole class of herbicide chemistries and other classes of herbicide chemistry have come into existence. These broad spectrum herbicides kill most types of plant life they come into contact with. They are typically used to kill vegetation when there is no need to differentiate between desirable and undesirable plants in the spray application area.

However, recent advancements in genetic engineering have developed many types of crops, such as soybeans, canola and corn, which are genetically altered to withstand the glyphosate-based herbicides or other types of broad spectrum herbicides. This enables farmers to plant their crops of soybeans, corn or other crops. Then when weeds or other undesirable plants begin to grow in the field, the entire field is treated with an herbicide that kills all the unwanted plants and the field is left with only the desired genetically altered plants remaining.

The foregoing examples of the related art and limitations related therewith are intended to be illustrative and not exclusive. Other limitations of the related art will become apparent to those of skill in the art upon a reading of the specification.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Due to the shortcomings of the prior art, it is an objective of the present invention to provide a method for attracting wildlife using seed that has been genetically engineered to resist or be tolerant to herbicides or using seed that is naturally resistant or tolerant to herbicides.

Another objective of the present invention is to provide a method for attracting wildlife using a food plot wherein herbicide resistant or tolerant seeds are selected such that a broad spectrum herbicide such as one based on glyphosate can be applied to kill unwanted plants and weeds yet leave the desired plants in place. This provides a cost effective and labor efficient method to weed the food plot and maximize the yield of the food plot. This in turn will provide more food for the wildlife and attract larger numbers of wildlife.

Another aspect of the present invention is to provide a mixture of herbicide tolerant seeds.

It is a further objective of the present invention to provide a method of packaging and marketing a selection of various genetically engineered seed for use in attracting wildlife. The exact ratios of the seeds packages together will vary depending upon the climate, geography and desired wildlife to attract.

Another aspect of the present invention is to provide a package of herbicide tolerant seeds.

Other objects, features, and advantages will be apparent to persons of ordinary skill in the art in view of the following detailed description of preferred embodiments.

### DEFINITIONS

In the description and tables that follow, a number of terms are used. In order to provide a clear and consistent understanding of the specification and claims, including the scope to be given such terms, the following definitions are provided:

Climatic requirement. Climatic requirement means the climate demands of the particular area where the food plot is located. It may refer to the season of the year as well.

Food plot. Food plot means an area of land planted with plants specifically to attract wildlife.

Herbicide tolerant. Herbicide tolerant means seeds or plants that are tolerant of or resistant to one or more herbicides. That is, the germination and/or growth of the seed or plant is minimally affected by application of one or more herbicides.

Mixture. A mixture or mix refers to whole seeds of two or more types of seeds physically mixed together.

Package. A package refers to a mixture of seeds packaged together in an appropriate type of package for use in seeding a food plot.

Planting. Planting means broadcasting seed over the top of the soil and/or burying seed into the top of the soil.

Soil condition. Soil condition means the soil condition of the particular area where the food plot is located. It may refer to the soil of the food plot as amended specifically for planting particular types of seed to attract particular types of wildlife.

Types of seed. Types of seed means a species or variety of seed such as corn or clover.

### DETAILED DESCRIPTION OF THE INVENTION

The present invention is a method for attracting wildlife through the planting of herbicide tolerant genetically engineered seed or naturally occurring herbicide tolerant species in a food plot. The invention includes the mixing of various types of herbicide tolerant seeds to match the geographic and climatic conditions as well as the types of wildlife desired. The invention addresses the mixing of all seed species that are resistant to herbicides as a consequence of genetic manipulation through laboratory-induced gene transformation efforts utilizing recombinant DNA technology or as a consequence of natural tolerance to herbicides. While numerous crop seed mixtures are presently available as planting seed to produce plants which serve as a food source for wild animals, none of the presently available mixtures are tolerant to broad spectrum herbicides. The result is that many weeds (i.e. undesirable plants) come up with the desirable plants and compete with the desirable plants for resources (space, water, sunlight and nutrients). The result is decreased production of the desirable plants with an attendant decrease in wildlife food per area of planting. While it is possible to maintain weed-free wildlife plots without the use of herbicides, the investment of time and resources needed to do so through mechanical means makes it impractical.

The product as packaged in accordance with the present invention would be a package containing two or more herbicide tolerant seeds. The ratio of mixture of the different types of seeds could be varied as required to meet the soil conditions, climatic, geographic or other needs of the location of the food plot. Likewise, the ratio could also be manipulated to match the type of wildlife desired.

The end user would purchase the premixed herbicide tolerant seed to fit the application intended. The user would then select an open piece of land adjacent to wildlife habitat. Typically, the food plot is approximately one quarter of an acre for every ten acres of habitat. It is also important that the food plot have at least 50% sunshine. Therefore, continuously shady areas are not typically used. The seed can be planted, either by broadcast seeding or by burying it in the ground. Once the seed has germinated and sprouted, the area can be sprayed with a broad spectrum herbicide such as glyphosate, glufosinate, or other chemical for which genetically engineered plant tolerance has been developed. This will kill off all the unwanted plants or weeds while the desired plants would remain. The presence of the plant and its fruits would provide a food source for the wildlife living in the adjacent habitat and in turn would attract additional wildlife to the area.

### EXAMPLE 1

### Examples of Mixes

Table 2 below shows examples of seed mixes and the proportions of those mixes. Column 1 shows the plant species of component of the mix while the remaining columns show the percentage of each species or component in the mix. For example, column 2 shows mix number 1 which is a clover mix consisting of 50-60% crimson clover, 30-40% red clover and 1-5% white clover.

TABLE 2
Examples of Mixes and Percent Composition for Species Included in Each Mix

| | Mix Number | | | | | | | | | | | | | | | | | | | |
|---|---|---|---|---|---|---|---|---|---|---|---|---|---|---|---|---|---|---|---|---|
| Species/Component | 1 | 2 | 3 | 4 | 5 | 6 | 7 | 8 | 9 | 10 | 11 | 12 | 13 | 14 | 15 | 16 | 17 | 18 | 19 | 20 |
| Crimson clover | 50-60 | | 15-25 | | | 20 | | | | | | | | | | | | 19 | | |
| Red clover | 30-40 | | | | | 10 | | | | | | | 15 | | | | | | | 20 |
| White clover | 1-5 | | 5-15 | | | 10 | | 10 | | | | | 15 | | | | | | 5 | |
| Ryegrass | | 50-60 | 55-65 | | | | | | | | | | | | | | | | | |
| Rape | | 20-30 | | 5-15 | | 10 | | | | | 25 | | 20 | | | | | 24 | 15 | 10 |
| Turnip | | 10-20 | | | | | | | | | 45 | | | | | | | | 20 | |
| Kale | | 5-15 | | | | 30 | | | | | 10 | | | | | | | | | |
| Annual ryegrass | | | | 75-85 | | | | | | | | 5 | 10 | | | | | | | |
| Arrowleaf Clover | | | 5-15 | | | | | | | | | | | | | | | | | |
| Berseem Clover | | | | 5-15 | | | | | | | | | | | | | | | | |
| Austrian winter peas | | | | | 35-45 | | | | | | | | | | | 17 | | 2 | | |
| Madsen wheat | | | | | 35-45 | | | | | | | | | | | | | | | |
| Mancan buckwheat | | | | | 15-35 | | | | | | | | | | | | | | | |
| Cowpeas | | | | | | | 20 | 50 | | 30 | | | | | | | | | | |
| Buckwheat | | | | | | | | | | 10 | | | | | 10 | | 10 | | | |
| Clover | | | | | | | | | 5 | | | 3 | 40 | | | | | | 20 | 15 |
| Alfalfa | | | | | | | | 10 | | | | | | | | | | | | |
| Birdsfoot trefoil | | | | | | | | | | | | | | | | 4 | | | | 20 |
| Oats | | | | | | | | | 35 | | | 30 | | | | | | 14 | | |
| Cereal rye | | | | | | | | | 15 | | | 30 | | | | | | 9 | 20 | |
| Wheat | | | | | | | | | 45 | | | 30 | | | | | | 8 | | |
| Sorghum | | | | | | | | 10 | | 10 | | | | 85 | 45 | | 10 | | | |
| Millet | | | | | | | | 10 | | | | | | 15 | 35 | | 10 | | | 35 |
| Peas | | | | | | | 45 | | | | | | | | | 9 | 35 | | | |
| Sunflower | | | | | | | | 10 | | 10 | | | | | 10 | 9 | | | | |
| Soybean | | | | | | | 35 | | | 40 | | | | | | 34 | 35 | | | |
| Chicory | | | | | | 10 | | | | | | | | | | | | 11 | 10 | |
| Mustard | | | | | | | | | | | 20 | | | | | | | | | |
| Tonic Plantain | | | | | | | | | | | | | | | | | | 11 | | |
| Radish | | | | | | | | | | | | | | | | | | 2 | | |
| Niagara Big Bluestem | | | | | | | | | | | | | | | | 14 | | | | |
| Switchgrass | | | | | | | | | | | | | | | | 4 | | | | |
| Indian Grass | | | | | | | | | | | | | | | | 9 | | | | |

### EXAMPLE 2

An embodiment of the present invention is a clover mix comprising about 50-60% crimson clover, 30-40% red clover and 1-5% white clover (shown as mix 1 in Table 2). Other percentages and combinations of these varieties are within the scope of the invention. Clovers are attractive to many types of wildlife including deer, turkey and rabbit. Clovers also enrich the soil with nitrogen since they are legumes. In addition, many populations of clover are unexpectedly naturally resistant to glyphosate so food plots planted with a clover mix can be sprayed with glyphosate to reduce or eliminate weeds leaving the clover for the wildlife. (Shock, C. C., et al. 1996. Prowl herbicide in alfalfa and red clover seed production. Malheur Experiment Station, Oregon State University, Ontario, Oreg.)

### EXAMPLE 3

Another embodiment of the present invention is a mix of 50-60% ryegrass, 20-30% rape, 10-20% turnip and 5-15% kale (shown as mix 2 in Table 2). Other percentages and combinations of these varieties are within the scope of the invention. This mix is attractive to a variety of wildlife including deer and hogs. Many canolas are herbicide tolerant and this is easily transferred to rape. For example see U.S. Pat. Nos. 6,969,786 and 6,921,850 and U.S. Patent Publication 20050278812. Unexpectedly, there are also a number of naturally occurring ryegrasses that are glyphosate resistant (Shinn, S. L. et al., 2004. Tolerance of Several Perennial Grasses to Imazapic. Weed Technology. 18(1):60-65.)

### EXAMPLE 4

A mix of 55-65% ryegrass, 15-25% crimson clover, 5-15% arrowleaf clover and 5-15% white clover is another embodiment of the invention (shown as mix 3 in Table 2). Other percentages and combinations of these varieties are within the scope of the invention. This mix is attractive to a variety of wildlife including deer, dove and turkey. The clover enriches the soil with nitrogen lessening the need for additional fertilizer. Unexpectedly, many ryegrasses and clovers are naturally tolerant of glyphosate and can be sprayed with glyphosate to reduce or eliminate unwanted weeds leaving the rye and clover for the wildlife. See above.

### EXAMPLE 5

Another embodiment of the invention is a mix of 75-85% annual ryegrass, 5-15% rape and 5-15% manna berseem clover (shown as mix 4 in Table 2). Other percentages and combinations of these varieties are within the scope of the invention. This mix is attractive to a variety of wildlife including deer, dove, and hogs. Many canolas are herbicide tolerant and this is easily transferred to rape. Unexpectedly, many ryegrasses and clovers are naturally tolerant of glyphosate and can be sprayed with glyphosate to reduce or eliminate unwanted weeds leaving the rye and clover for the wildlife. See above.

### EXAMPLE 6

Another aspect of the invention is a mix of 35-45% Austrian winter peas, 35-45% madsen wheat and 15-25% mancan buckwheat (shown as mix 5 in Table 2). Other percentages and combinations of these varieties are within the scope of the invention. This mix is attractive to a variety of wildlife including deer, quail, pheasant, dove, duck and turkey. Both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075). Unexpectedly, buckwheat also displays herbicide tolerance (Wall, D. A. and M. A. H. Smith (2000). See also, Wall, D. A. et al., (2000). Tolerance of common buckwheat (Fagopyrum esculentum) to low rates of 2, 4-D and MCPA. Canadian Journal of Plant Science. 80(2): 407-410 and Friesen, G. H. et al., (1986). Common buckwheat (Fagopyrum esculentum (cultivar Mancan)) tolerance to herbicides. Weed Science 34(3): 435-439).

### EXAMPLE 7

A further embodiment of the invention is a mix of 20% crimson clover, 10% red clover, 10% white clover, 10% rape, 30% kale and 10% chicory (shown as mix 6 in Table 2). Other percentages and combinations of these varieties are within the scope of the invention. Clovers are attractive to many types of wildlife including deer, turkey and rabbit. Clovers also enrich the soil with nitrogen since they are legumes. In addition, many populations of clover are unexpectedly naturally resistant to glyphosate so food plots planted with a clover mix can be sprayed with glyphosate to reduce or eliminate weeds leaving the clover for the wildlife. (Shock, C. C., et al. 1996. Prowl herbicide in alfalfa and red clover seed production. Malheur Experiment Station, Oregon State University, Ontario, Oreg.) Many canolas are herbicide tolerant and this is easily transferred to rape. For example see U.S. Pat. Nos. 6,969,786 and 6,921,850 and U.S. Patent Publication 20050278812.

### EXAMPLE 8

Another aspect of the invention is a mix of 20% cowpeas, 45% peas and 35% soybeans (shown as mix 7 in Table 2). Other percentages and combinations of these varieties are within the scope of the invention. This mix is attractive to a variety of wildlife including deer, quail, turkey and dove. Cowpeas are already tolerant to herbicides used for controlling grasses and are currently being screened for tolerance to herbicides used for controlling broadleaf weeds (Burgos, N. R. et al., Screening of cowpeas for tolerance to herbicides. Department of Crop, Soil, and Environmental Sciences and Department of Horticulture, University of Arkansas). Extensive research and breeding efforts have resulted in a large number of soybean varieties with herbicide resistance which are readily available.

### EXAMPLE 9

A further embodiment of the invention is a mix of 10% white clover, 50% cowpeas, 10% alfalfa, 10% sorghum, 10% millet, and 10% sunflower (shown as mix 8 in Table 2). Other percentages and combinations of these varieties are within the scope of the invention. This mix is attractive to a variety of wildlife including deer, turkey, rabbit, raccoon and quail.

### EXAMPLE 10

Another aspect of the invention is a mix of 5% clover, 35% oats, 15% cereal rye and 45% wheat (shown as mix 9 in Table 2). Other percentages and combinations of these varieties are within the scope of the invention.

### EXAMPLE 11

A further embodiment of the invention is a mix of 30% cowpeas, 10% buckwheat, 10% sorghum, 10% sunflower and 40% soybean (shown as mix 10 in Table 2). Other percentages and combinations of these varieties are within the scope of the invention.

### EXAMPLE 12

Another aspect of the invention is a mix of 25% rape, 45% turnip, 10% kale and 20% mustard (shown as mix 11 in Table 2). Other percentages and combinations of these varieties are within the scope of the invention.

### EXAMPLE 13

A further embodiment of the invention is a mix of 5% annual ryegrass, 3% clover, 30% oats, 30% cereal rye and 30% wheat (shown as mix 12 in Table 2). Other percentages and combinations of these varieties are within the scope of the invention.

### EXAMPLE 14

Another aspect of the invention is a mix of 15% red clover, 15% white clover, 20% rape, 10% annual ryegrass and 40% clover (shown as mix 13 in Table 2). Other percentages and combinations of these varieties are within the scope of the invention.

### EXAMPLE 15

A further embodiment of the invention is a mix of 85% sorghum and 15% millet (shown as mix 14 in Table 2). Other percentages and combinations of these varieties are within the scope of the invention.

### EXAMPLE 16

Another aspect of the invention is a mix of 10% buckwheat, 45% sorghum, 35% millet and 10% sunflower (shown as mix 15 in Table 2). Other percentages and combinations of these varieties are within the scope of the invention.

### EXAMPLE 17

A further embodiment of the invention is a mix of 17% Austrian winter peas, 4% birdsfoot trefoil, 9% peas, 9% sunflower, 34% soybean, 14% Niagara big bluestem, 4% switchgrass and 9% Indian grass (shown as mix 16 in Table 2). Other percentages and combinations of these varieties are within the scope of the invention.

### EXAMPLE 18

Another aspect of the invention is a mix of 10% buckwheat, 10% sorghum, 10% millet, 35% peas and 35% soybean (shown as mix 17 in Table 2). Other percentages and combinations of these varieties are within the scope of the invention.

### EXAMPLE 19

A further embodiment of the invention is a mix of 19% crimson clover, 24% rape, 2% Austrian winter peas, 14% oats, 9% cereal rye, 8% wheat, 11% chicory 11% tonic plantain and 2% radish (shown as mix 18 in Table 2). Other percentages and combinations of these varieties are within the scope of the invention.

### EXAMPLE 20

Another aspect of the invention is a mix of 5% white clover, 15% rape, 20% turnip, 20% clover, 20% cereal rye and 10% chicory (shown as mix 19 in Table 2). Other percentages and combinations of these varieties are within the scope of the invention.

### EXAMPLE 21

A further embodiment of the invention is a mix of 20% red clover, 10% rape, 15% clover, 20% birdsfoot trefoil, and 35% millet (shown as mix 20 in Table 2). Other percentages and combinations of these varieties are within the scope of the invention.

### EXAMPLE 22

Another aspect of the invention is a mix of cowpeas, lablab, American jointvetch, alyceclover and buckwheat. This is a mix of warm season annuals and is attractive to a variety of wildlife including deer, quail, turkey and dove. For attracting game birds the mix is weighted to buckwheat and cowpeas whereas for attracting deer, the mix is more evenly weighted among all the varieties. As previously mentioned, many buckwheat and clover populations are naturally herbicide tolerant. Cowpeas are already tolerant to herbicides used for controlling grasses and are currently being screened for tolerance to herbicides used for controlling broadleaf weeds (Burgos, N. R. et al., Screening of cowpeas for tolerance to herbicides. Department of Crop, Soil, and Environmental Sciences and Department of Horticulture, University of Arkansas).

### EXAMPLE 23

A further embodiment of the invention is a mix of clover, alfalfa, birdsfoot trefoil and Austrian winter peas. This is a mix of cool season perennials and is attractive to a variety of wildlife including deer, turkey and rabbit. As previously mentioned, many clover populations are naturally herbicide tolerant. Bromoxynil, Clethodim, and Imazethapyr can safely be used on alfalfa to control both broadleaf weeds and grasses (Brubacher, M. et al., 1999. Weed Control in Seedling Alfalfa, Using Post Emergent Herbicide Treatments. University of California Cooperative Extension, Farm Advisor, Colusa County). Austrian winter peas are tolerant of various herbicides such as Metribuzin and Terbutryne depending on the particular cultivar (Lemerle, D. et al. 1991. Tolerances of canola, field pea, lupin and faba bean cultivars to herbicides. Australian Journal of Experimental Agriculture 31:379-86).

### EXAMPLE 24

Another aspect of the invention is a mix of crimson clover, arrowleaf clover, oats, cereal rye and wheat. This is a mix of cool season annuals and is attractive to a variety of wildlife including deer, turkey, rabbit, dove, and quail. As previously mentioned, many clover populations are naturally herbicide tolerant. There are also many populations of wild oats that are naturally herbicide tolerant and this tolerance is easily transferred to cereal oats (Van Acker, R., et al. 2004. Multiple herbicide resistant wild oat: occurrence and evolutionary mechanism. Agri-Food Research and Development Initiative, Manitoba, Canada). Generally, any herbicide that is approved for use with grasses can be used with cereal rye and wheat. As previously mentioned, both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075).

### EXAMPLE 25

Another aspect of the invention is a mix of corn, soybean, sorghum (milo) and sunflower. This mix is attractive to a variety of wildlife including deer, turkey, quail, dove and raccoon. Extensive research and breeding efforts have resulted in a large number of corn, soybean and sunflower varieties with herbicide resistance which are readily available. Sorghum is tolerant to a variety of herbicides as well and since it is related to corn, any number of herbicide resistance genes from corn are easily transferred to sorghum.

### EXAMPLE 26

Another aspect of the invention is a mix of sorghum (milo), wheat, millet, and buckwheat. This mix is attractive to a variety of wildlife including deer, turkey, quail, dove, pheasant and duck. Sorghum is tolerant to a variety of herbicides as well and since it is related to corn, any number of herbicide resistance genes from corn are easily transferred to sorghum. There are a few herbicides currently labelled for use with pearl millet, such as glyphosate. Pearl millet is a grass and herbicide resistance genes can be transferred to it from other grasses through genetic engineering or through other means. As previously mentioned, both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075). Unexpectedly, buckwheat also displays herbicide tolerance (Wall, D. A. and M. A. H. Smith (2000). See also, Wall, D. A. et al., (2000). Tolerance of common buckwheat (Fagopyrum esculentum) to low rates of 2, 4-D and MCPA. Canadian Journal of Plant Science. 80(2): 407-410 and Friesen, G. H. et al., (1986). Common buckwheat (Fagopyrum esculentum (cultivar Mancan)) tolerance to herbicides. Weed Science 34(3): 435-439).

### EXAMPLE 27

Another aspect of the invention is a mix of peas, cowpeas, buckwheat and millet. This mix attracts a variety of wildlife including deer, quail, dove, pheasant, and duck. Austrian winter peas are tolerant of various herbicides such as Metribuzin and Terbutryne depending on the particular cultivar (Lemerle, D. et al. 1991. Tolerances of canola, field pea, lupin and faba bean cultivars to herbicides. Australian Journal of Experimental Agriculture 31:379-86). Cowpeas are already tolerant to herbicides used for controlling grasses and are currently being screened for tolerance to herbicides used for controlling broadleaf weeds (Burgos, N. R. et al., Screening of cowpeas for tolerance to herbicides. Department of Crop, Soil, and Environmental Sciences and Department of Horticulture, University of Arkansas). Unexpectedly, buckwheat displays herbicide tolerance (Wall, D. A. and M. A. H. Smith (2000). See also, Wall, D. A. et al., (2000). Tolerance of common buckwheat (Fagopyrum esculentum) to low rates of 2, 4-D and MCPA. Canadian Journal of Plant Science. 80(2): 407-410 and Friesen, G. H. et al., (1986). Common buckwheat (Fagopyrum esculentum (cultivar Mancan)) tolerance to herbicides. Weed Science 34(3): 435-439). There are a few herbicides currently labelled for use with pearl millet, such as glyphosate. Pearl millet is a grass and herbicide resistance genes can be transferred to it from other grasses through genetic engineering or through other means.

### EXAMPLE 28

Another aspect of the invention is a mix of oats, buckwheat, sorghum (milo) and millet. This mix is attractive to a variety of wildlife including deer, dove, quail, pheasant, and duck. There are many populations of wild oats that are naturally herbicide tolerant and this tolerance is easily transferred to cereal oats (Van Acker, R., et al. 2004. Multiple herbicide resistant wild oat: occurrence and evolutionary mechanism. Agri-Food Research and Development Initiative, Manitoba, Canada). Unexpectedly, buckwheat displays herbicide tolerance (Wall, D. A. and M. A. H. Smith (2000). See also, Wall, D. A. et al., (2000). Tolerance of common buckwheat (Fagopyrum esculentum) to low rates of 2, 4-D and MCPA. Canadian Journal of Plant Science. 80(2): 407-410 and Friesen, G. H. et al., (1986). Common buckwheat (Fagopyrum esculentum (cultivar Mancan)) tolerance to herbicides. Weed Science 34(3): 435-439). Sorghum is tolerant to a variety of herbicides as well and since it is related to corn, any number of herbicide resistance genes from corn are easily transferred to sorghum. There are a few herbicides currently labelled for use with pearl millet, such as glyphosate. Pearl millet is a grass and herbicide resistance genes can be transferred to it from other grasses through genetic engineering or through other means.

### EXAMPLE 29

Another aspect of the invention is a mix of sunflower, cereal rye, wheat and corn. This mix is attractive to a variety of wildlife including dove, quail, turkey, deer, raccoon and hogs. Extensive research and breeding efforts have resulted in a number of sunflower and corn varieties with herbicide resistance which are readily available. Generally, any herbicide that is approved for use with grasses can be used with cereal rye and wheat. As previously mentioned, both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075).

### EXAMPLE 30

Another aspect of the invention is a mix of sunflower, sorghum (milo), corn, wheat, and millet. This mix is attractive to a variety of wildlife including dove, quail, turkey, deer, raccoon and hogs. Extensive research and breeding efforts have resulted in a number of sunflower and corn varieties with herbicide resistance which are readily available. Sorghum is tolerant to a variety of herbicides as well and since it is related to corn, any number of herbicide resistance genes from corn are easily transferred to sorghum. Generally, any herbicide that is approved for use with grasses can be used with wheat. As previously mentioned, both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075). There are a few herbicides currently labelled for use with pearl millet, such as glyphosate. Pearl millet is a grass and herbicide resistance genes can be transferred to it from other grasses through genetic engineering or through other means.

### EXAMPLE 31

Another embodiment of the invention is a mix of sunflower, sorghum (milo), corn, barley, and cowpeas. This mix is attractive to a variety of wildlife including dove, quail, turkey, deer, raccoon and hogs. Extensive research and breeding efforts have resulted in a number of sunflower and corn varieties with herbicide resistance which are readily available. Sorghum is tolerant to a variety of herbicides as well and since it is related to corn, any number of herbicide resistance genes from corn are easily transferred to sorghum. Generally, any herbicide that is approved for use with grasses can be used with barley. Cowpeas are already tolerant to herbicides used for controlling grasses and are currently being screened for tolerance to herbicides used for controlling broadleaf weeds (Burgos, N. R. et al., Screening of cowpeas for tolerance to herbicides. Department of Crop, Soil, and Environmental Sciences and Department of Horticulture, University of Arkansas).

### EXAMPLE 32

Another embodiment of the invention is a mix of sorghum (milo), corn, wheat, millet, oats, and cereal rye. This mix is attractive to a variety of wildlife including dove, quail, pheasant, turkey, deer, raccoon and hogs. Sorghum is tolerant to a variety of herbicides as well and since it is related to corn, any number of herbicide resistance genes from corn are easily transferred to sorghum. Extensive research and breeding efforts have resulted in a number of corn varieties with herbicide resistance which are readily available. As previously mentioned, both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075). There are a few herbicides currently labelled for use with pearl millet, such as glyphosate. Pearl millet is a grass and herbicide resistance genes can be transferred to it from other grasses through genetic engineering or through other means. There are many populations of wild oats that are naturally herbicide tolerant and this tolerance is easily transferred to cereal oats (Van Acker, R., et al. 2004. Multiple herbicide resistant wild oat: occurrence and evolutionary mechanism. Agri-Food Research and Development Initiative, Manitoba, Canada). Generally, any herbicide that is approved for use with grasses can be used with cereal rye.

### EXAMPLE 33

Another embodiment of the invention is a mix of sorghum (milo), corn, buckwheat, barley and cowpeas. This mix is attractive to a variety of wildlife including dove, quail, duck, pheasant, turkey, deer, raccoon and hogs. Sorghum is tolerant to a variety of herbicides as well and since it is related to corn, any number of herbicide resistance genes from corn are easily transferred to sorghum. Extensive research and breeding efforts have resulted in a number of corn varieties with herbicide resistance which are readily available. Unexpectedly, buckwheat displays herbicide tolerance (Wall, D. A. and M. A. H. Smith (2000). See also, Wall, D. A. et al., (2000). Tolerance of common buckwheat (Fagopyrum esculentum) to low rates of 2, 4-D and MCPA. Canadian Journal of Plant Science. 80(2): 407-410 and Friesen, G. H. et al., (1986). Common buckwheat (Fagopyrum esculentum (cultivar Mancan)) tolerance to herbicides. Weed Science 34(3): 435-439). Generally, any herbicide that is approved for use with grasses can be used with barley. Cowpeas are already tolerant to herbicides used for controlling grasses and are currently being screened for tolerance to herbicides used for controlling broadleaf weeds (Burgos, N. R. et al., Screening of cowpeas for tolerance to herbicides. Department of Crop, Soil, and Environmental Sciences and Department of Horticulture, University of Arkansas).

### EXAMPLE 34

Another embodiment of the invention is a mix of sunflower, sorghum (milo), corn wheat, millet, oats, cereal rye, buckwheat, barley and cowpeas. This mix is attractive to a variety of wildlife including dove, quail, duck, pheasant, turkey, deer, raccoon and hogs. Extensive research and breeding efforts have resulted in a number of sunflower and corn varieties with herbicide resistance which are readily available. Sorghum is tolerant to a variety of herbicides as well and since it is related to corn, any number of herbicide resistance genes from corn are easily transferred to sorghum. As previously mentioned, both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075). There are a few herbicides currently labelled for use with pearl millet, such as glyphosate. Pearl millet is a grass and herbicide resistance genes can be transferred to it from other grasses through genetic engineering or through other means. There are many populations of wild oats that are naturally herbicide tolerant and this tolerance is easily transferred to cereal oats (Van Acker, R., et al. 2004. Multiple herbicide resistant wild oat: occurrence and evolutionary mechanism. Agri-Food Research and Development Initiative, Manitoba, Canada). Generally, any herbicide that is approved for use with grasses can be used with cereal rye and barley. Unexpectedly, buckwheat displays herbicide tolerance (Wall, D. A. and M. A. H. Smith (2000). See also, Wall, D. A. et al., (2000). Tolerance of common buckwheat (Fagopyrum esculentum) to low rates of 2, 4-D and MCPA. Canadian Journal of Plant Science. 80(2): 407-410 and Friesen, G. H. et al., (1986). Common buckwheat (Fagopyrum esculentum (cultivar Mancan)) tolerance to herbicides. Weed Science 34(3): 435-439). Cowpeas are already tolerant to herbicides used for controlling grasses and are currently being screened for tolerance to herbicides used for controlling broadleaf weeds (Burgos, N. R. et al., Screening of cowpeas for tolerance to herbicides. Department of Crop, Soil, and Environmental Sciences and Department of Horticulture, University of Arkansas).

### EXAMPLE 35

Another embodiment of the invention is a mix of oats, buckwheat, sorghum (milo), millet, sunflower, cereal rye, wheat, and corn. This mix is attractive to a variety of wildlife including dove, quail, duck, pheasant, turkey, deer, raccoon and hogs. There are many populations of wild oats that are naturally herbicide tolerant and this tolerance is easily transferred to cereal oats (Van Acker, R., et al. 2004. Multiple herbicide resistant wild oat: occurrence and evolutionary mechanism. Agri-Food Research and Development Initiative, Manitoba, Canada). Unexpectedly, buckwheat displays herbicide tolerance (Wall, D. A. and M. A. H. Smith (2000). See also, Wall, D. A. et al., (2000). Tolerance of common buckwheat (Fagopyrum esculentum) to low rates of 2, 4-D and MCPA. Canadian Journal of Plant Science. 80(2): 407-410 and Friesen, G. H. et al., (1986). Common buckwheat (Fagopyrum esculentum (cultivar Mancan)) tolerance to herbicides. Weed Science 34(3): 435-439). Sorghum is tolerant to a variety of herbicides as well and since it is related to corn, any number of herbicide resistance genes from corn are easily transferred to sorghum. There are a few herbicides currently labelled for use with pearl millet, such as glyphosate. Pearl millet is a grass and herbicide resistance genes can be transferred to it from other grasses through genetic engineering or through other means. Extensive research and breeding efforts have resulted in a number of sunflower and corn varieties with herbicide resistance which are readily available. Generally, any herbicide that is approved for use with grasses can be used with cereal rye. As previously mentioned, both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075).

### EXAMPLE 36

Another embodiment of the invention is a mix of corn, soybean, sorghum (milo), sunflower, wheat, millet, buckwheat, peas, and cowpeas. This mix is attractive to a variety of wildlife including dove, quail, duck, pheasant, turkey, deer, raccoon and hogs. Extensive research and breeding efforts have resulted in a number of corn, soybean and sunflower varieties with herbicide resistance which are readily available. Sorghum is tolerant to a variety of herbicides as well and since it is related to corn, any number of herbicide resistance genes from corn are easily transferred to sorghum. As previously mentioned, both genetically engineered herbicide tolerant wheat and, unexpectedly, naturally occurring herbicide tolerant wheat, exist and are available for this mix. (See Harker, K. N., et al. 2005. Glyphosate-resistant spring wheat production system effects on weed communities. Weed Science. 53(4):451-464; Harker, K. N., et al. 2005. Glyphosate-resistant wheat persistence in western Canadian cropping systems. Weed Science. 53(6):846-859; Lyon, Drew J., et al. 2002. Pest Management Implications of glyphosate-resistant wheat (Triticum aestivum) in the western United States. Weed Technology. 16(3):680-690; Rainbolt, Curtis R. et al., 2005. Imidazolinone-Resistant Wheat Acetolactate Synthase In Vivo Response to Imazamox. Weed Technology. 19(3):539-548; Zhou, H., et al. 2003. Field efficacy assessment of transgenic Roundup Ready wheat. Crop Sci. 43(3):1072-1075). There are a few herbicides currently labelled for use with pearl millet, such as glyphosate. Pearl millet is a grass and herbicide resistance genes can be transferred to it from other grasses through genetic engineering or through other means. Unexpectedly, buckwheat displays herbicide tolerance (Wall, D. A. and M. A. H. Smith (2000). See also, Wall, D. A. et al., (2000). Tolerance of common buckwheat (Fagopyrum esculentum) to low rates of 2, 4-D and MCPA. Canadian Journal of Plant Science. 80(2): 407-410 and Friesen, G. H. et al., (1986). Common buckwheat (Fagopyrum esculentum (cultivar Mancan)) tolerance to herbicides. Weed Science 34(3): 435-439). Austrian winter peas are tolerant of various herbicides such as Metribuzin and Terbutryne depending on the particular cultivar (Lemerle, D. et al. 1991. Tolerances of canola, field pea, lupin and faba bean cultivars to herbicides. Australian Journal of Experimental Agriculture 31:379-86). Cowpeas are already tolerant to herbicides used for controlling grasses and are currently being screened for tolerance to herbicides used for controlling broadleaf weeds (Burgos, N. R. et al., Screening of cowpeas for tolerance to herbicides. Department of Crop, Soil, and Environmental Sciences and Department of Horticulture, University of Arkansas).

The foregoing specifications are only illustrative of the preferred embodiments of the present invention. They should not be interpreted as limiting the scope of the attached claims. Those skilled in the arts will be able to come up with equivalent embodiments of the present invention without departing from the spirit and scope thereof.

What is claimed is:

1. A method for luring wildlife comprising planting two or more types of herbicide tolerant seeds in a food plot, waiting for the seeds to germinate, and spraying plants in the food plot with a broad spectrum herbicide.

2. The method of claim 1, wherein one or more of the broad spectrum herbicides is selected from the group of chemical families consisting of glyphosate, glufosinate, the sulfonylurea class of herbicide chemistries and the imidazole class of herbicide chemistries.

3. The method of claim 1, wherein one or more of the types of seeds selected are from the group consisting of alfalfa, bahia, birdsfoot trefoil, brome buckwheat, canola, chufas, clover, corn, cowpeas, crimson clover, red clover white clover, ryegrass, turnip, kale, annual ryegrass, arrowleaf clover, berseem clover, Austrian winter peas, madsen wheat, mancan buckwheat, lablab, American jointvetch, Alyceclover, oats, cereal rye, barley, peas, chicory, mustard, tonic plantain, radish, Niagara big bluestem, Indian grass, deer food, millet, lespedeza, rape, sorghum, soybeans, switchgrass and wheat.

4. A mixture of herbicide tolerant seeds, wherein one or more of the herbicide tolerant seeds are selected from the group consisting of alfalfa, bahia, birdsfoot trefoil, brome buckwheat, canola, chufas, clover, corn, cowpeas, crimson clover, red clover white clover, ryegrass, turnip, kale, annual ryegrass, arrowleaf clover, berseem clover, Austrian winter peas, madsen wheat, mancan buckwheat, lablab, American jointvetch, Alyceclover, oats, cereal rye, barley, peas, chicory, mustard, tonic plantain, radish, Niagara big bluestem, Indian grass, deer food, millet, lespedeza, rape, sorghum, soybeans, switchgrass and wheat.

5. The method of claim 3, wherein each of the types of seeds selected has a certain ratio to one another based upon the percentage of each type of seed selected with regard to the entire amount of seed.

6. The method of claim 5, wherein the ratio of types of herbicide resistant seeds planted is varied to attract a certain type of wildlife.

7. The method of claim 5, where in the ratio of types of herbicide resistant seeds is varied to meet a climatic requirement of the food plot.

8. The method of claim 5, wherein the ratio of types of herbicide resistant seeds is varied to meet a soil condition of the food plot.

9. The method of claim 5, wherein the ratio of types of herbicide resistant seeds is varied to meet another need of the food plot.

10. A method for marketing seed for luring wildlife comprising selecting two or more types of herbicide resistant seeds, mixing and packaging the two or more types of seeds together, and selling the packaged seeds.

11. The method of claim 10, wherein the two or more of the types of seeds selected are selected from the group consisting of alfalfa, bahia, birdsfoot trefoil, brome buckwheat, canola, chufas, clover, corn, cowpeas, crimson clover, red clover white clover, ryegrass, turnip, kale, annual ryegrass, arrowleaf clover, berseem clover, Austrian winter peas, madsen wheat, mancan buckwheat, lablab, American jointvetch, Alyceclover, oats, cereal rye, barley, peas, chicory, mustard, tonic plantain, radish, Niagara big bluestem, Indian grass, deer food, millet, lespedeza, rape, sorghum, soybeans, switchgrass and wheat.

12. A package of herbicide tolerant seed produced by the method of claim 11.

13. The method of claim 11, wherein each of the types of seeds selected has a certain ratio to one another based upon the percentage of each type of seed selected with regard to the entire amount of seed.

14. The method of claim 13, wherein the ratio of types of herbicide resistant seeds planted is varied to attract a certain type of wildlife.

15. The method of claim 13, wherein the ratio of types of herbicide resistant seeds is varied to meet a climatic requirement of the food plot.

16. The method of claim 13, wherein the ratio of types of herbicide resistant seeds is varied to meet a soil condition of the food plot.

17. The method of claim 13, wherein the ratio of types of herbicide resistant seeds is varied to meet another need of the food plot.
